(19) United States
(12) Patent Application Publication
(10) Pub. No.: US 2018/0368948 A1
(43) Pub. Date: Dec. 27, 2018

(54) Geared Orthodontic Buccal Tube

(71) Applicant: Oklahoma Medical Research Foundation, Oklahoma Cit y, OK (US)

(72) Inventor: Abraham Thomas, Thiruvananthapuram (IN)

(21) Appl. No.: 15/776,494

(22) PCT Filed: Nov. 28, 2016
(86) PCT No.: PCT/IN2016/050422

§ 371 Date: May 16, 2018

(30) Foreign Application Priority Data
Nov. 26, 2015 (IN) 6361/CHE/2015

(51) Int. Cl. A61C 7/36; A61C 7/28; A61C 7/12

(52) U.S. Cl. CPC A61C 7/36; A61C 7/125; A61C 7/282

(57) ABSTRACT

The present invention includes a geared orthodontic buccal tube assembly which comprises of a buccal tube with an elongated hook that engages one or more gearwheels which in turn engage a toothed surfaces to redirect the direction of the applied force pulling the buccal tube to prevent or reduce the movement of the anchor tooth thus reinforcing the anchor teeth.

### TECHNICAL FIELD OF THE INVENTION

The present invention relates in general to the field of orthodontics, and more particularly, to anchor teeth in orthodontics.

### BACKGROUND OF THE INVENTION

Without limiting the scope of the invention, its background is described in connection with orthodontics. In orthodontics, a set of teeth are moved, using a single tooth or another set of teeth which are used as the anchor to initiate movement. The forward movement of these anchor teeth is not desired. The main anchor tooth is usually the first molar tooth. FIG. 1 is an image of a current fixed orthodontic treatment device 10. This anchor tooth 12 is usually banded with a molar band 14 which has a buccal tube 16 welded on to it; although, the anchor tooth 12 may include the buccal tube 16 bonded directly to the surface of the anchor tooth 12. The molar band 14 includes a wire slot 18 to receive a wire 20 and a hook 22 to provide an anchor point for an elastomeric band 23. The wire also extends through bonded bracket 24.

FIG. 2 is an image of a buccal tube 16 and includes a wire slot 18 to receive a wire 20 and a slot cover 26. A hook 22 is positioned on the buccal tube side to provide an anchor point. To prevent or minimize this unwanted movement, anchor teeth are reinforced through the use of headgears, transpalatal arches or temporary anchorage devices, increasing the number of anchor teeth to name a few. Through these methods more force can be applied on the reinforced anchor teeth so the orthodontic treatment minimizes unwanted movement and is faster without losing anchorage. Since orthodontic treatment typically takes a long time up to three years or even more, reducing treatment time and the number of visits to the orthodontist is a significant improvement in the treatment protocol.

### SUMMARY OF THE INVENTION

The present invention provides a device for maintaining a traction force on a tooth in a jaw comprising a band adapted to be positioned about the tooth; a bi-directional traction device housing adapted to attach to the buccal surface of the band, wherein the bi-directional traction device housing comprises a first toothed rack movably attached to the bi-directional traction device housing; a hook connected to the first toothed rack to receive an elastic that applies a traction in an first direction; a second toothed rack; and a toothed gear positioned between and in contact with the first toothed rack and the second toothed rack, wherein the movement of the hook moves the first toothed rack which rotates the toothed gear and transfers the force to the second toothed rack in an second direction. In another embodiment the first toothed rack has a top toothed surface and a bottom toothed surface and the bi-directional traction device housing further comprises a second toothed gear positioned between and in contact with the first toothed rack and a third toothed rack, wherein the movement of the hook moves the first toothed rack which rotates the toothed gear and moves the second toothed gear to transfer the force to the second toothed rack and the third toothed rack in an posterior direction.

The present invention provides a device for maintaining a traction force on a tooth in a jaw comprising a bi-directional traction device housing adapted to be banded or bonded to the buccal surface of the tooth, wherein the bi-directional traction device housing comprises a first toothed rack movably attached to the bi-directional traction device housing; a hook connected to the first toothed rack to receive an elastic that applies a traction in an first direction; a second toothed rack; and a toothed gear positioned between and in contact with the first toothed rack and the second toothed rack, wherein the movement of the hook moves the first toothed rack which rotates the toothed gear and transfers the force to the second toothed rack in an second direction.

The present invention provides a device for maintaining a traction force on a tooth in a jaw comprising a bi-directional traction device housing adapted to be banded or bonded to the buccal surface of the tooth, wherein the bi-directional traction device housing comprises a curved spring guide connected to the bi-directional traction device housing; a spring stop located at each end of the curved spring guide; one or more springs compressibly positioned over the curved spring guide; and a hook to receive an elastic that applies a traction in an first direction slidably positioned on the curved spring guide between the spring stop and the one or more springs, wherein the movement of the hook compresses the spring between the hook and the spring stop to transfers the force to the anchor tooth in an second direction.

In any of the embodiments disclosed herein the jaw may be the maxillary jaw, the mandibular jaw or both. The first direction may be an anterior direction and the second direction may be a posterior direction. The first direction may be a posterior direction and the second direction may be an anterior direction. The bi-directional traction device housing may be enclosed. The bi-directional traction device housing may be made from a metal, an alloy, a ceramic, a polymer, a plastic or a combination thereof. The ceramic may be a crystalline, an alumina, a tooth-shade or a clear synthetic sapphire. The device may further comprise a bumper unit connected to the bi-directional traction device housing. The bi-directional traction device housing further comprises a slotted bracket to engage an archwire. The first toothed rack may be connected to an outer plate having one or more hooks, wherein the movement of the one or more hooks moves the outer plate and in turn moves the first toothed rack. The tooth may be a mandibular posterior first tooth.

### BRIEF DESCRIPTION OF THE DRAWINGS

For a more complete understanding of the features and advantages of the present invention, reference is now made to the detailed description of the invention along with the accompanying figures and in which:

FIG. 1 is an image of a current fixed orthodontic treatment device 10.

FIG. 2 is an image of a buccal tube 16 and includes a wire slot 18 to receive a wire 20 and a slot cover 26.

FIG. 3 is a side view of one embodiment of the present invention.

FIG. 4 is a cross sectional image of the tensioning device having a single gear.

FIG. 5 is a cross sectional image of the tensioning device having a dual gears.

FIG. 6 is a perspective view of the buccal tube 16 and includes a wire slot 18 to receive a wire 20 and house the gears.

FIG. 7 is a perspective view of the buccal tube 16 that includes a spring tensioning mechanism 44.

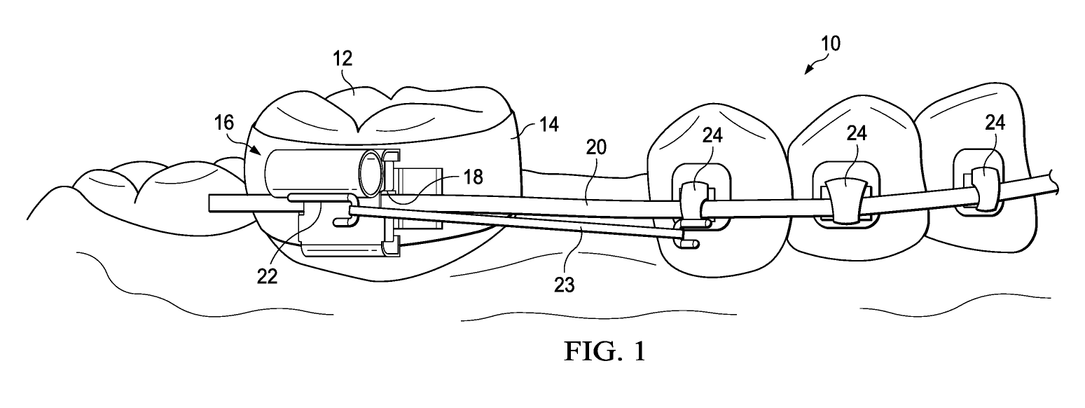

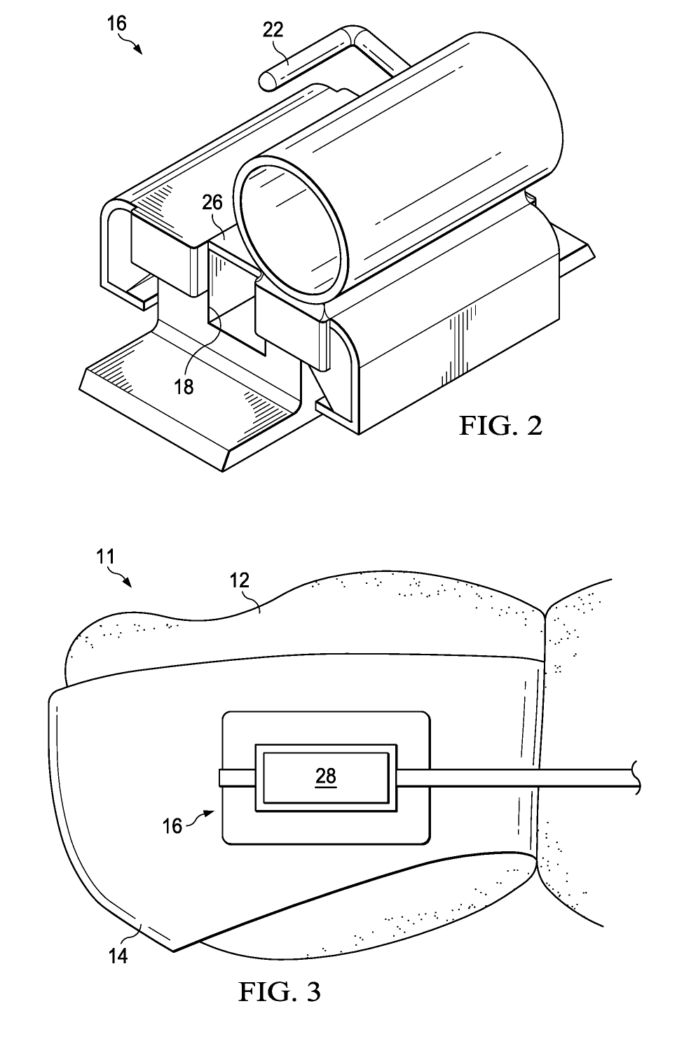

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

In orthodontic procedures, an anchor tooth is usually banded with a molar band which has a buccal tube that connects to a wire fitted into a wire slot and a hook to provide an anchor point for an elastomeric band. The wire also extends through the mouth over other teeth through bonded brackets on each side of a missing/extracted tooth to close or reduce that gap. Elastics bands are positioned across the missing/extracted tooth space to close spaces. In addition to elastics bands, springs, elastic chains and other similar functioning devices may be used. The molar tooth is the anchor tooth and it should not move into the missing/extracted tooth space, hence low forces are used through the use of light elastics. However, in the prior art devices this low force is not optimal but necessary to reduce movement of the anchor tooth. The present invention increases the force to a more optimal level without causing forward movement or minimizing forward movement of the anchor tooth. Another, benefit of the present invention is the considerably reduction in the treatment time resulting from greater force being used on the anchor tooth.

Some prior art devices are used to accomplish this increased force using different mechanisms. For example one popular device is a Temporary Anchorage Devices (TAD), which places small biocompatible screws into the bone for attachment of an elastics band(s) to provide a greater force and removed the screw after the treatment.

The present invention reduces the orthodontic treatment time significantly by applying greater force without moving the anchor tooth. FIG. 3 is a side view of one embodiment of the present invention. The fixed orthodontic treatment device 11 includes a molar band 14 about an anchor tooth 12. The molar band 14 has a buccal tube 16 welded on to it and a tensioning device 28 loosely riveted to the buccal tube 16.

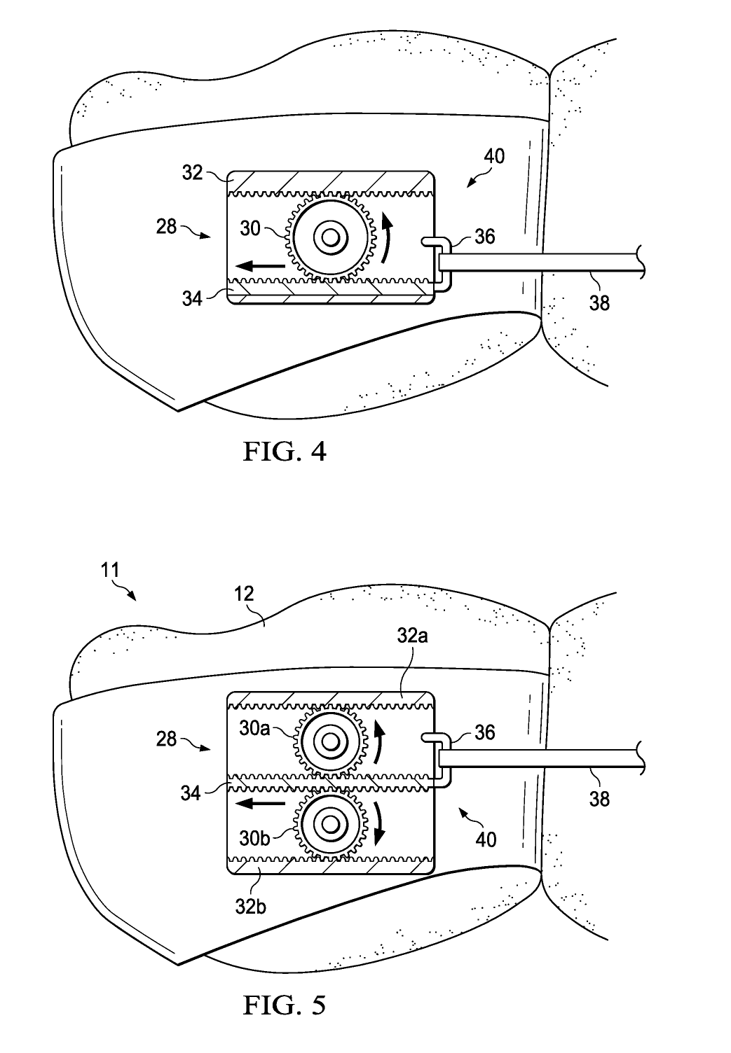

FIG. 4 is a cross sectional image of the tensioning device 28. The tensioning device 28 has a rotatably attached single gear 30 positioned between a toothed rack 32 and a toothed movable member 34 having a hook 36 attached to a tensioning mechanism 38 at a first end 40. The tensioning mechanism 38 pulls on the hook 36 causing the toothed movable member 34 to move toward the first end 40 and rotates the single gear 30 in a direction away from the first end 40 (counterclockwise). The single gear 30 engages the toothed rack 32 such that as the single gear 30 rotates it moves the toothed rack 32 in the direction of that movement (away from the first end 40). Although, it is evident that the reversal of the positions of the toothed rack 32 and the toothed movable member 34 would result in the opposite movement of the single gear 30 but produces the same results. The tensioning device 28 allows the application of greater force on the tensioning mechanism 38 without moving the anchor tooth 12 and resulting in a considerably reduction in the treatment time.

FIG. 5 is a cross sectional image of the tensioning device 28 having dual gears. The tensioning device 28 has a toothed movable member 34 positioned between a rotatably attached first gear 30a and a rotatably attached second gear 30b. The rotatably attached first gear 30a also engages an upper toothed rack 32a. The rotatably attached second gear 30b also engages a lower toothed rack 32b. The toothed movable member 34 includes a hook 36 attached to a tensioning mechanism 38 at a first end 40. The tensioning mechanism 38 pulls on the hook 36 causing the toothed movable member 34 to move toward the first end 40 and rotates the rotatably attached first gear 30a in a counterclockwise direction and rotates the rotatably attached second gear 30b in a clockwise direction. The counterclockwise movement of the rotatably attached first gear 30a transfers to the upper toothed rack 32a to move away from the first end 40. The clockwise movement of the rotatably attached second gear 30b transfers to the lower toothed rack 32b to move away from the first end 40. As a result of the tensioning mechanism 38 applying force towards the first end 40, the gears (first gear 30a and second gear 30b) movement transfers the force away from the first end 40. This allows the application of greater force on the tensioning mechanism 38 without moving the anchor tooth 12 and resulting in a considerably reduction in the treatment time.

In one embodiment, the hook 36 consists of an about 6 millimeter long piece of biocompatible material (e.g., stainless steel, titanium, alloys, polymer, etc) which is rectangular in cross section and has dimensions of about 0.014×0.016 of an inch and generally from 0.002 to 0.5×0.002 to 0.5 of an inch and all incremental variations thereof. However, the hook 36 may be other lengths (e.g., 2, 3, 4, 5, 7, 8, 9, 10, or 11 mm) and have different dimensions as necessary. The hook 36 is at one end of this toothed movable member 34 and the rest of the surface has a cogged or toothed surface on two opposing surfaces. This cogged or toothed surface engages into the teeth of two small cogwheels or gearwheels (rotatably attached gear 30a and 30b) on either side. These cogs or gearwheels in turn also engage themselves into opposing cogged or toothed surfaces (upper toothed rack 32a and lower toothed rack 32b). This whole assembly is encased in stainless steel or a polymeric casing and fixed except for the hook 36 to prevent the members of the assembly from falling out or becoming jammed. This whole unit is mounted on the surface of the buccal tube. This stainless steel cased unit may be fixed or riveted on to the buccal tube 16 so it can swivel to the direction of force applied in different types of cases in orthodontics.

This whole assembly is encased in stainless steel (or any biocompatible material including polymers, metals, alloys, etc.) and the one cog or two cogs (depending on requirement) is loosely riveted to prevent the cogs or gearwheels from losing alignment and remaining in their positions. When force is applied to the hook 36 it will move in the direction of force forcing the two cogs (rotatably attached gear 30a and 30b) or gearwheels to rotate. This would cause the fixed opposing cogged or toothed surfaces to which the two cogs or gearwheels interlock to produce a force in the opposite direction of the force applied to the hook 36 of the assembly. The cogs or cog will rotate on a fixed axis. Since this unit is mounted on the buccal tube 16 which is bonded or banded on the anchor tooth 12, the force generated is transmitted to the anchor tooth 12. This prevents or reduces the forward movement of the anchor tooth 12 which allows the orthodontist to use more force to reduce treatment time. This would also dispel the need to use other methods of reinforcing anchorage which vary from nonintrusive to intrusive methods like headgears, transpalatal arches, temporary anchorage devices, increasing the number of anchor teeth.

The assembly may be attached with mechanisms other than riveting, including pins, screws, bolts, shafts, etc. Similarly, the assembly itself may be made from different materials including metals, polymers alloys and the like. In addition, the assembly may be made from combinations of materials, e.g., a metal back with a polymer cover, a polymer back with an alloy cover, a polymer back and cover with metal sides, or a metal back and cover with polymer sides, a polymer back and sides with a metal cover and so forth. Similarly, the cogs, gears and toothed racks may be constructed from plastic, polymers, metals, alloys and so forth. In addition, the number and position of the gears or cogs may vary depending on the specific application needs.

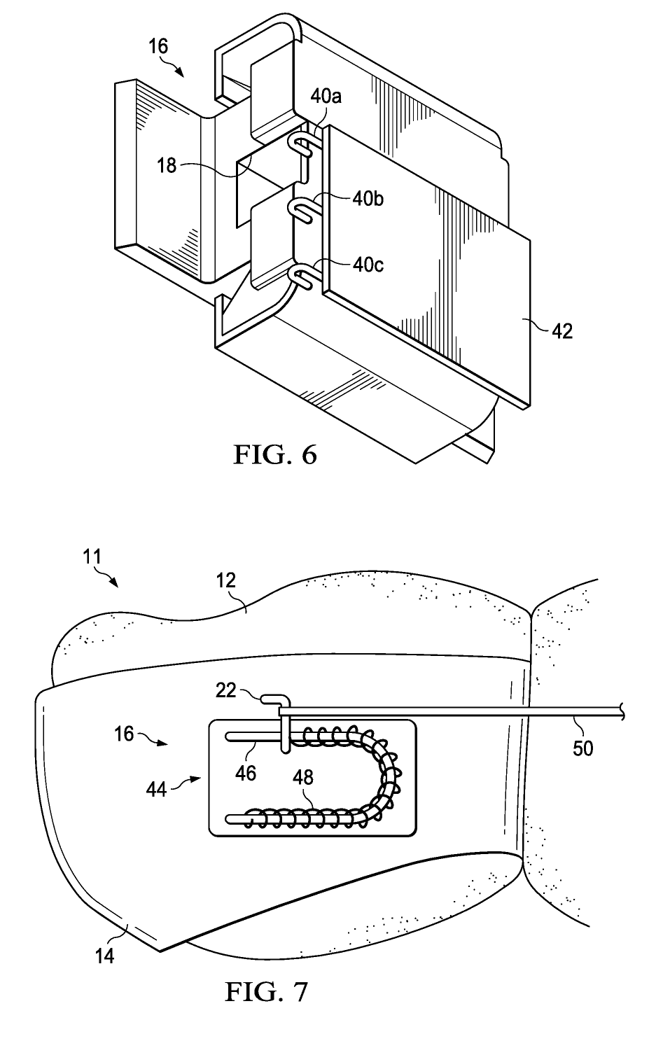

FIG. 6 is a perspective view of the buccal tube 16 and includes a wire slot 18 to receive a wire (not shown) and to house the gears (not shown). The hooks 40a, 40b, and 40c are to accept or engage tensioning devices at various positions for plate 42, which can be loosely attached, riveted, slid into a tab and groove, pressed, crimped or other attachment mechanism. They can also be modified to accept wires as in 18 so the wire (20) can be inserted through or crimped to 34, 36, 40a, 40b and 40c. In some embodiments the plate 42 is fixed in part to allow the plate 42 to swing out on its axis to the direction of the force. In other embodiments the plate 42 is fixed in position. The plate 42 serves to cover the internal mechanisms of the assembly from falling out or becoming jammed or engaging the cheek with the opened gear surface. This whole assembly is encased in stainless steel or a polymeric casing with the plate 42 covering the face. This whole assembly is encased in stainless steel or a polymeric casing and fixed except for the hook 36 to prevent the members of the assembly from falling out or becoming jammed. This whole unit is mounted on the surface of the buccal tube. This stainless steel cased unit may be fixed or riveted on to the buccal tube 16 so it can swivel to the direction of force applied in different types of cases in orthodontics.

FIG. 7 is a perspective view of the buccal tube 16 that includes a spring tensioning mechanism 44. The molar band 14 is positioned about an anchor tooth 12. The molar band 14 has a buccal tube 16 welded on to it and a spring tensioning mechanism 44 loosely riveted to the buccal tube 16. The spring tensioning mechanism 44 includes a track 46 that may be of any shape or profile necessary and in this example shows a “U” shape and a round profile. The track 46 includes a spring mechanism 48 having a hook 22 at one end. The spring mechanism 48 moves about the track 46 such that a force is applied to resist the movement of the hook 22. In operation, an elastic band 50 is connected to the hook 22 such that it pulls away from the anchoring position of the track 46 to compress the spring 48. As the spring 48 is compressed it in turn applies a force in the opposite direction. In another embodiment, a “U” shaped track is attached to a buccal tube to allow a swivel motion and having a spring (e.g., shape memory Nickel Titanium Springs) compressionally positioned about the track. The spring is secured at one end and has a hook at the other end. A tensioning device is attached to the hook to apply tension to the device such that the force is transferred to the buccal tube in a backwards direction

The gears of the present invention may be as simple as a cog and rack configuration; a rack and pinion gear type; worm gears and worm wheel; spur gear; helical gear; or as complicated as multiple gears that interact to increase or reduce the gearing and the force applied. A rack is a toothed bar or rod that can be thought of as a sector gear with an infinitely large radius of curvature. Torque can be converted to linear force by meshing a rack with a pinion: the pinion turns; the rack moves in a straight line. Racks also feature in the theory of gear geometry, where, for instance, the tooth shape of an interchangeable set of gears may be specified for the rack (infinite radius), and the tooth shapes for gears of particular actual radii are then derived from that. Worm-and-gear sets are a simple and compact way to achieve a high torque, low speed gear ratio. A worm gear is a species of helical gear, but its helix angle is usually somewhat large (close to 90 degrees) and its body is usually fairly long in the axial direction. These attributes give it screw like qualities. The distinction between a worm and a helical gear is that least one tooth persists for a full rotation around the helix. If this occurs, it is a “worm”; if not, it is a “helical gear”. A worm may have as few as one tooth. If that tooth persists for several turns around the helix, the worm appears, superficially, to have more than one tooth, but what one in fact sees is the same tooth reappearing at intervals along the length of the worm. The usual screw nomenclature applies: a one-toothed worm is called single thread or single start; a worm with more than one tooth is called multiple thread or multiple start. The helix angle of a worm is not usually specified. Instead, the lead angle, which is equal to 90 degrees minus the helix angle, is given. In a worm-and-gear set, the worm can always drive the gear. However, if the gear attempts to drive the worm, it may or may not succeed. Particularly if the lead angle is small, the gear teeth may simply lock against the worm teeth, because the force component circumferential to the worm is not sufficient to overcome friction. Spur gears or straight-cut gears consist of a cylinder or disk with the teeth projecting radially, and although the teeth are not straight-sided (they are usually of special form to achieve constant drive ratio, mainly involute but less commonly cycloidal), the edge of each tooth is straight and aligned parallel to the axis of rotation. These gears can be meshed together correctly only if they are fitted to parallel shafts.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

1. A device for maintaining a traction force on a tooth in a jaw comprising
a band adapted to be positioned about the tooth;
a bi-directional traction device housing adapted to attach to the buccal surface of the band, wherein the bi-directional traction device housing comprises
a first toothed rack movably attached to the bi-directional traction device housing;
a hook connected to the first toothed rack to receive an elastic that applies a traction in an first direction;
a second toothed rack;
a toothed gear positioned between and in contact with the first toothed rack and the second toothed rack, wherein the movement of the hook moves the first toothed rack which rotates the toothed gear and transfers the force to the second toothed rack in an second direction; and
a plate attached to enclose the bi-directional traction device housing.

2. A device for maintaining a traction force on a tooth in a jaw comprising
a bi-directional traction device housing adapted to be bonded to the buccal surface of the tooth, wherein the bi-directional traction device housing comprises
a first toothed rack movably attached to the bi-directional traction device housing;
a hook connected to the first toothed rack to receive an elastic that applies a traction in an first direction;
a second toothed rack;
a toothed gear positioned between and in contact with the first toothed rack and the second toothed rack, wherein the movement of the hook moves the first toothed rack which rotates the toothed gear and transfers the force to the second toothed rack in an second direction; and
a plate attached to enclose the bi-directional traction device housing.

3. The device of claim 2, wherein the jaw is the maxillary jaw, the mandibular jaw or both.

4. The device of claim 3, wherein the tooth is a mandibular posterior first tooth.

5. The device of claim 2, wherein the first direction is an anterior direction and the second direction is a posterior direction.

6. The device of claim 2, wherein the first direction is a posterior direction and the second direction is an anterior direction.

7. The device of any of claim 2, wherein the first toothed rack has a top toothed surface and a bottom toothed surface and the bi-directional traction device housing further comprises a second toothed gear positioned between and in contact with the first toothed rack and a third toothed rack, wherein the movement of the hook moves the first toothed rack which rotates the toothed gear and moves the second toothed gear to transfer the force to the second toothed rack and the third toothed rack in an posterior direction.

8. The device of any of claim 2, wherein the bi-directional traction device housing is made from a metal, an alloy, a ceramic, a polymer, a plastic or a combination thereof.

9. The device of any of claim 2, wherein the ceramic is a crystalline, an alumina, a tooth-shade or a clear synthetic sapphire.

10. The device of any of claim 2, further comprising a bumper unit connected to the bi-directional traction device housing.

11. The device of any of claim 2, wherein the bi-directional traction device housing further comprises a bracket having a groove to engage an archwire.

12. A device for maintaining a traction force on a tooth in a jaw comprising:
a bi-directional traction device housing adapted to be bonded to the buccal surface of the tooth, wherein the bi-directional traction device housing comprises
a first toothed rack movably attached to the bi-directional traction device housing;
a hook connected to the first toothed rack to receive an elastic that applies a traction in an first direction;
a second toothed rack;
a toothed gear positioned between and in contact with the first toothed rack and the second toothed rack, wherein the movement of the hook moves the first toothed rack which rotates the toothed gear and transfers the force to the second toothed rack in an second direction and
a plate attached to enclose the bi-directional traction device housing.

13. A device for maintaining a traction force on a tooth in a jaw comprising:
a bi-directional traction device housing adapted to be bonded to the buccal surface of the tooth, wherein the bi-directional traction device housing comprises
a curved spring guide connected to the bi-directional traction device housing;
a spring stop located at each end of the curved spring guide;
one or more springs compressibly positioned over the curved spring guide;
a hook to receive an elastic that applies a traction in an first direction slidably positioned on the curved spring guide between the spring stop and the one or more springs, wherein the movement of the hook compresses the spring between the hook and the spring stop to transfers the force to anchor tooth in an second direction; and
a plate attached to enclose the bi-directional traction device housing.

14. The device of claim 13, wherein the jaw is the maxillary jaw, the mandibular jaw or both.

15. The device of claim 13, wherein the tooth is a mandibular posterior first tooth.

16. The device of claim 13, wherein the first direction is an anterior direction and the second direction is a posterior direction.

17. The device of claim 13, wherein the first direction is a posterior direction and the second direction is an anterior direction.

18. The device of claim 13, further comprising a bumper unit connected to the bi-directional traction device housing.

19. The device of claim 13, wherein the bi-directional traction device housing further comprises a bracket having a slot to engage an archwire.
